(19) United States
(12) Patent Application Publication
(10) Pub. No.: US 2013/0215031 A1
(43) Pub. Date: Aug. 22, 2013

(54) ROLLER MODULE FOR INPUT DEVICE

(71) Applicants: Chun-Ching Peng, Taipei (TW); Chun-Nan Su, Taipei (TW)

(72) Inventors: Chun-Ching Peng, Taipei (TW); Chun-Nan Su, Taipei (TW)

(73) Assignee: PRIMAX ELECTRONICS LTD., Taipei (TW)

(21) Appl. No.: 13/555,648

(22) Filed: Jul. 23, 2012

(30) Foreign Application Priority Data
Feb. 17, 2012 (TW) 101105279

(51) Int. Cl. G06F 3/033

(52) U.S. Cl. 345/163

(57) ABSTRACT

The present invention discloses a roller module for an input device. The roller module includes a circuit board, a wheel swinging element arranged above the circuit board, a wheel arranged on the wheel swinging element, a mode switching element arranged between the circuit board and the wheel swinging element, a plurality of switches arranged between the circuit board and the wheel swinging element, and a micro control unit. When the wheel is moved downward a distance relative to the wheel swinging element, the wheel can't be rotated. When the wheel is pushed such that the wheel swinging element is tilted in a specific direction or moved downward, the corresponding one of the switches or the mode switching elements is triggered. When the mode switching element is triggered, the roller module is switched from a first working mode to a second working mode.

### FIELD OF THE INVENTION

The present invention generally relates to a roller module, and more particularly to a roller module for an input device.

### BACKGROUND OF THE INVENTION

With the rapid advancement of technology and the advents of the multimedia age and the computer age, the dependence of the people on various computer apparatuses is increased. As a result, various peripheral input devices for being the communications between the computer systems and the users, such as a mouse, a keyboard, a microphone and so on, play a vital role. Since the operation manner of the mouse device, which can be held by the user with his palm for controlling the movement of the mouse cursor and then the trajectory of the mouse cursor can be outputted on the computer screen, is so close to the using habit of the human being, the mouse device becomes the most common one of the peripheral input devices.

In addition, it is usually necessary to scroll an image of a window on the computer screen in a horizontal direction and a vertical direction for achieving to completely read whole of the image due to a size of the image of a document file or a web page is too large when a user browses the document file or the web page. However, a wheel of the conventional mouse device is merely capable of being rolled about a single rolling shaft, i.e. for scrolling the image of the window on the computer screen in the vertical direction. In contrast, it is necessary to scroll the image of the window on the computer screen in the horizontal direction by continuously pressing the left button accompanied by moving the mouse device in the horizontal direction. Such kind of mouse device only having the single rolling shaft is already difficult to satisfy the user with the usage of browsing the document file or the web page, and thus a mouse device with a tilting type wheel capable of shifting the image of the window on the computer screen in the horizontal direction is introduced.

FIG. 1 illustrates an external schematic view of a conventional tilting wheel mouse device. Referring to FIG. 1, the mouse device 1 with the tilting type wheel comprises a case 10 and a wheel 11, and the case 10 has an opening 101, so that the wheel 11 is capable of protruding out of a surface of the case 10 for being rolled or poked by the user. The mouse device 1 with the tilting type wheel outputs a first control command to a computer for processing a first function, for example scrolling a window in an image of a window on a computer screen in a vertical direction, when the user rolls the wheel 11 in a frontward direction or a rearward direction (i.e. a direction D1 or a direction D2 as shown in FIG. 1). In contrast, the mouse device 1 with the tilting type wheel outputs a second control command to the computer for processing a second function, for example scrolling the window in the image of the window on the computer screen in a horizontal direction, when the user poked the wheel 11 in a leftward direction or a rightward direction (i.e. a direction D3 or a direction D4 as shown in FIG. 1).

Although the conventional mouse device 1 with the tilting type wheel 11 is capable of being rolled in the frontward/rearward direction (the direction D1 and the direction D2) and poked in the leftward/rightward direction (the direction D3 and the direction D4), the wheel 11 is easy to be rolled in the frontward/rearward direction at the same time when the user tends to poked the wheel 11 in the leftward/rightward direction with his index finger due to the user usually provides an external force to the wheel 11 with his index finger in an improper direction. As a result, the computer determines to process both of the first control command and the second control command after receives both of the first control signal and the second control signal at the same time, that results in an incorrect operation to the user, and such incorrect operation is considerable distress to the user.

In addition, with the professional software for the present computer becoming more diversified, the professional software can process much more functions, and the operation thereof consequently becomes more complicated. Hence, the conventional mouse device 1 with the tilting type wheel 11 is difficult to satisfy the user's requirement due to it is only able to be rolled in the frontward/rearward direction and poked in the leftward/rightward direction.

In view of this, another mouse device 1 with the tilting type wheel 11 and arranged with a mode switching button 12 is commercially available, and the wheel 11 of the mouse device 1 is able to achieve more operation functions as long as the user presses or adjusts the mode switching button 12. For example, it is able to horizontally scroll the window in the image of the window on the computer screen by poking the wheel 11 in the leftward direction or the rightward direction when the wheel 11 of the mouse device 1 is in an initial working mode. In contrast, it can shift the window in the image of the window on the computer screen to a previous one page and a next one page by respectively poking the wheel 11 in the leftward direction and the rightward direction when the user presses or adjusts the mode switching button 12 to switch the wheel 11 of the mouse device 1 to in another working mode.

However, the mode switching button 12 is usually arranged on a surface of the case 10 of the mouse device 1, such as located on a side surface of the case 10 of the mouse device 1, but located on a bottom surface of the case 10 of the mouse device 1 is possible as well. As a result, it is necessary to press or to adjust the mode switching button 12 by using another finger other than the index finger when the user desires to switch the mode of the mouse device 1. Alternatively, the user is necessary to turn over the case 10 of the mouse device 1 before pressing or adjusting the mode switching button 12. As a result, the conventional mouse device with the tilting type wheel and arranged with the mode switching button is quite not easy to be operated by the user.

According to the above mentioned descriptions, those conventional mouse devices are still required to be improved.

### SUMMARY OF THE INVENTION

The present invention is directed to a roller module for an input device, and more particularly to a roller module capable of processing all functions and switching among working modes by an operation of a user with a single finger merely.

In a preferred embodiment, the present invention provides a roller module for an input device comprising:
a mode switching element, capable of being triggered to generate a mode switching signal;
a trigger sensing element set, capable of being triggered to correspondingly generate and thus output at least one control signal;
a circuit board, wherein the mode switching element and the trigger sensing element set are capable of being arranged on the circuit board;
a wheel swinging element, arranged above the circuit board, such that the mode switching element and the trigger sensing element set are located between the circuit board and the wheel swinging element;
a wheel, arranged on the wheel swinging element and capable of being rotated relative to the wheel swinging element, wherein the wheel is unable to be rotated when the wheel is provided with an external force and moved downward a distance relative to the wheel swinging element, and the mode switching element or the trigger sensing element set is triggered when the wheel is unable to be rotated and the wheel is provided with another external force for swinging or moving the wheel swinging element relative to the circuit board;
a first elastomer, capable of providing a first elastic force to the wheel, such that the wheel is moved upward relative to the wheel swinging element when the wheel is stopped to be provided with the external force;
a wheel sensing element, arranged adjacent to the wheel and capable of generating and thus outputting a wheel signal when the wheel rotates; and
a micro control unit, electrically connected with the mode switching element, the trigger sensing element set and the wheel sensing element, wherein the roller module is switched from a first working mode to a second working mode when the micro control unit receives the mode switching signal.

In a preferred embodiment, the micro control unit generates and thus outputs a first function command when the roller module is in the first working mode and the micro control unit receives the at least one control signal, while the micro control unit generates and thus outputs a second function command when the roller module is in the second working mode and the micro control unit receives the at least one control signal.

In a preferred embodiment, the micro control unit generates and thus outputs a first function command when the roller module is in the first working mode and the micro control unit receives the wheel signal, while the micro control unit generates and thus outputs a second function command when the roller module is in the second working mode and the micro control unit receives the wheel signal.

In a preferred embodiment, the wheel has an operation surface for an user operating thereon, and the operation surface has a plurality of recessions thereon, while the wheel swinging element has a protrusion located under the wheel, wherein the protrusion is contained within a recession of the plurality of recessions when the roller module is in a swinging mode.

In a preferred embodiment, the wheel has an operation surface for an user operating thereon, an upper surface of the wheel swinging element has a friction piece, and the wheel contacts the friction piece when the roller module is in a swinging mode.

In a preferred embodiment, the wheel swinging element has a first supporting piece and a second supporting piece, the wheel has a wheel shaft, and two ends of the wheel shaft are respectively arranged on the first supporting piece and the second supporting piece.

In a preferred embodiment, the first supporting piece has a first position limiting hole thereon, the second supporting piece has a second position limiting hole thereon, the two ends of the wheel shaft respectively pass through the first position limiting hole and the second position limiting hole, the first position limiting hole is capable of limiting one of the two ends of the wheel shaft to be merely moved in the first position limiting hole, and the second position limiting hole is capable of limiting the other one of the two ends of the wheel shaft to be merely moved in the second position limiting hole.

In a preferred embodiment, the first elastomer is formed as a bar, which encircles and is fixed on the first supporting piece and the second supporting piece, and is capable of supporting the two ends of the wheel shaft.

In a preferred embodiment, the trigger sensing element set comprises a first switch, a second switch, a third switch and a fourth switch, a bottom surface of the wheel swinging element has a first trigger portion, a second trigger portion, a third trigger portion and a fourth trigger portion respectively corresponding to the first switch, the second switch, the third switch and the fourth switch, and the first switch, the second switch, the third switch and the fourth switch are respectively arranged at a front side, a rear side, a left side and a right side on the circuit board.

In a preferred embodiment, the mode switching element is arranged among the first switch, the second switch, the third switch and the fourth switch, and the bottom surface of the wheel swinging element has a press trigger portion corresponding to the mode switching element.

In a preferred embodiment, the mode switching element is an elastomer with an elastic modulus larger than an elastic modulus of the first elastomer.

In a preferred embodiment, the first switch and the second switch are respectively capable of controlling an image of a window on a computer screen to shift to a previous one page and a next one page when the roller module is in the first working mode.

In a preferred embodiment, the third switch and the fourth switch are respectively capable of horizontally scrolling an image of a window on a computer screen when the roller module is in the first working mode.

In a preferred embodiment, the first switch, the second switch, the third switch and the fourth switch are respectively capable of providing a forward pointing function, a rearward pointing function, a leftward pointing function and a rightward pointing function when the roller module is in the second working mode.

In a preferred embodiment, at least one of the first switch, the second switch, the third switch and the fourth switch is capable of switching among application programs in a computer system when the roller module is in the second working mode.

In a preferred embodiment, the roller module for an input device further comprises at least one second elastomer arranged between the wheel swinging element and the circuit board and capable of providing a second elastic force for the wheel swinging element.

In a preferred embodiment, an elastic modulus of the second elastomer is larger than an elastic modulus of the first elastomer.

In a preferred embodiment, the second elastomer is made of rubber material.

In a preferred embodiment, the trigger sensing element set is a resistance type pressure sensor or a capacitance type pressure sensor.

In a preferred embodiment, the wheel sensing element is an encoder.

In a preferred embodiment, the input device comprises a case, and an upper surface of the case has an opening capable of exposing a part of the wheel outside the case.

In a preferred embodiment, the input device is applied to a mouse device, a keyboard device or a mobile device.

### BRIEF DESCRIPTION OF THE DRAWINGS

FIG. 1 illustrates an external schematic view of a conventional tilting wheel mouse device.

FIG. 2 illustrates a structural schematic view of a roller module for an input device according to a first preferred embodiment of the present invention.

FIG. 3 illustrates a structural schematic view from another angle of the roller module as shown in FIG. 2.

FIG. 4 illustrates a perspective explosion view the roller module as shown in FIG. 2.

FIG. 5 illustrates a perspective explosion view from another angle of the roller module as shown in FIG. 2.

FIG. 6 illustrates a schematic block diagram of electrical connection relationships among each of the elements of the roller module as shown in FIG. 2.

FIG. 7A illustrates a schematic state view of the roller module as shown in FIG. 2 in an initial state.

FIG. 7B illustrates a schematic state view of the roller module as shown in FIG. 2 in a wheel locked state.

FIG. 8 illustrates a schematic operation function table of the roller module as shown in FIG. 2 in different working modes.

FIG. 9 illustrates a structural schematic view of a roller module for an input device according to a second preferred embodiment of the present invention.

FIG. 10 illustrates a structural schematic view from another angle of the roller module as shown in FIG. 9.

FIG. 11A illustrates a schematic state view of the roller module as shown in FIG. 9 in an initial state.

FIG. 11B illustrates a schematic state view of the roller module as shown in FIG. 9 when the wheel thereof is in a locked state.

FIG. 12 illustrates a structural schematic view of a circuit board, a second elastomer and a wheel swinging element of a roller module according to an embodied aspect of the present invention.

FIG. 13 illustrates a top view of the circuit board, the second elastomer and the wheel swinging element as shown in FIG. 12.

FIG. 14 illustrates a structural schematic view of a circuit board, a second elastomer and a wheel swinging element of a roller module according to another embodied aspect of the present invention.

FIG. 15 illustrates a perspective explosion view of the circuit board, the second elastomer and the wheel swinging element as shown in FIG. 14.

FIG. 16 illustrates a structural schematic view of a roller module for an input device according to a preferred embodied aspect of a second preferred embodiment of the present invention.

FIG. 17 illustrates a partial internal structural schematic view of the input device as shown in FIG. 16.

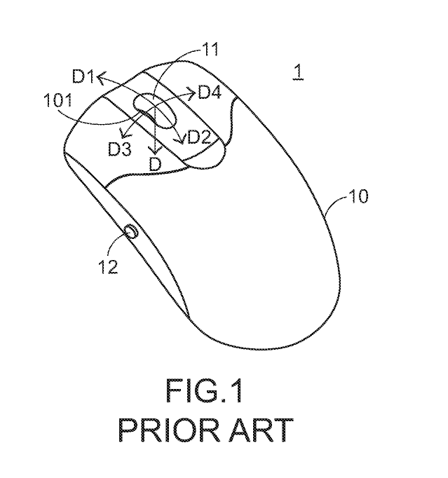

### DETAILED DESCRIPTION OF THE PREFERRED EMBODIMENT

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

The first thing to note is the present invention provides a roller module, the user is able to control a corresponding electronic equipment by operating the roller module, and the roller module is able to be arranged in various input devices, such as a mouse device, a keyboard device, a cell phone, a personal digital assistant (PDA) and so on. However, the fields to which the roller module is capable of being applied should not be limited herein.

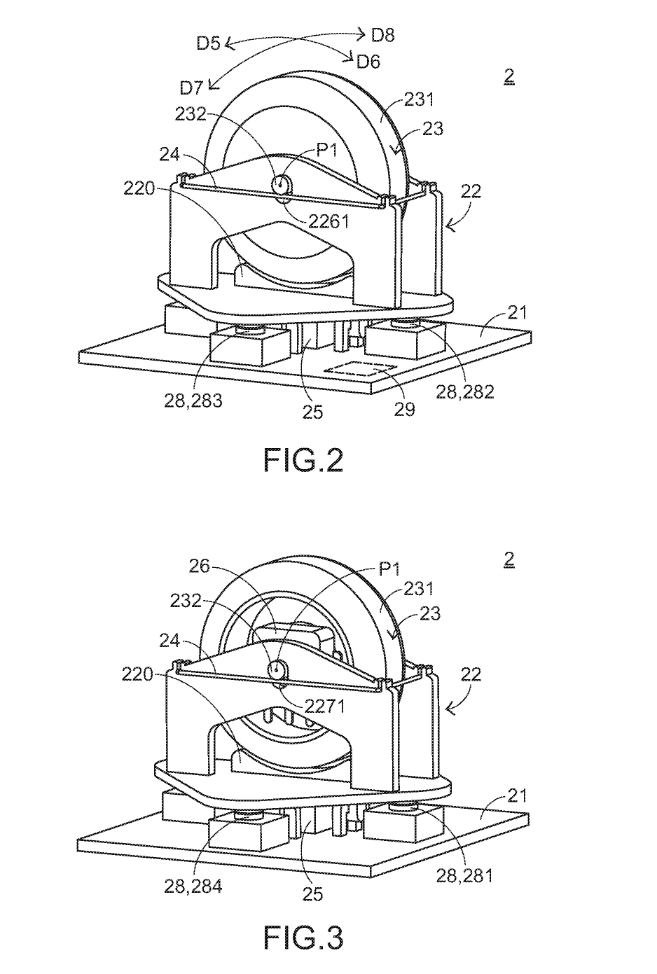

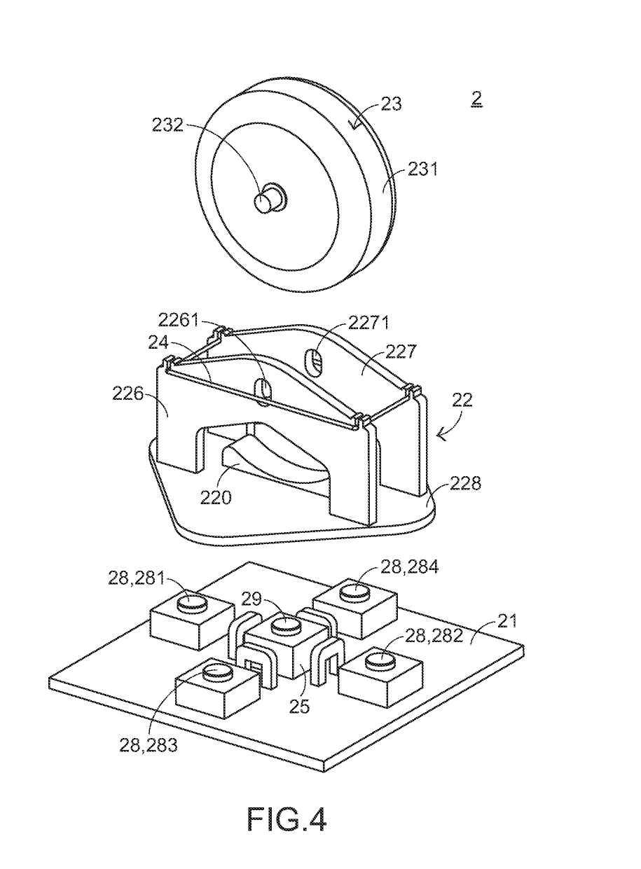

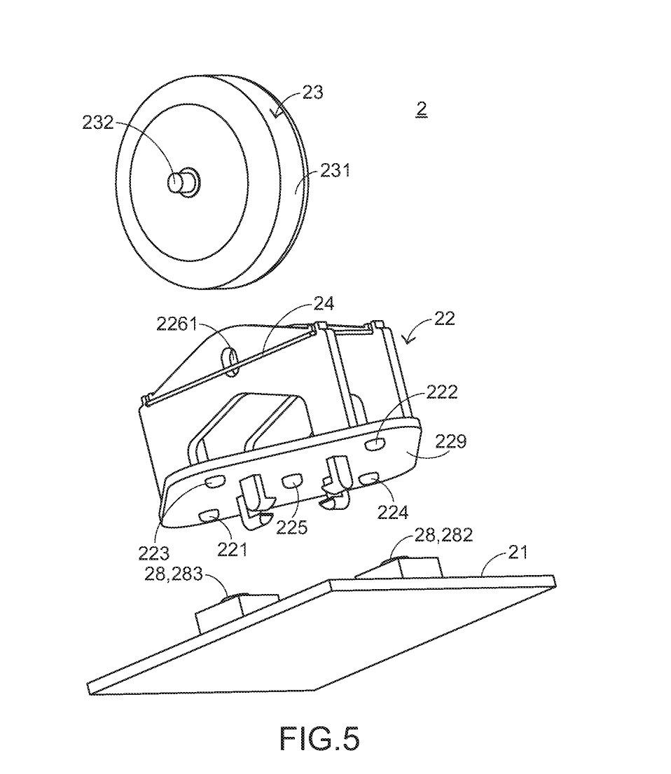

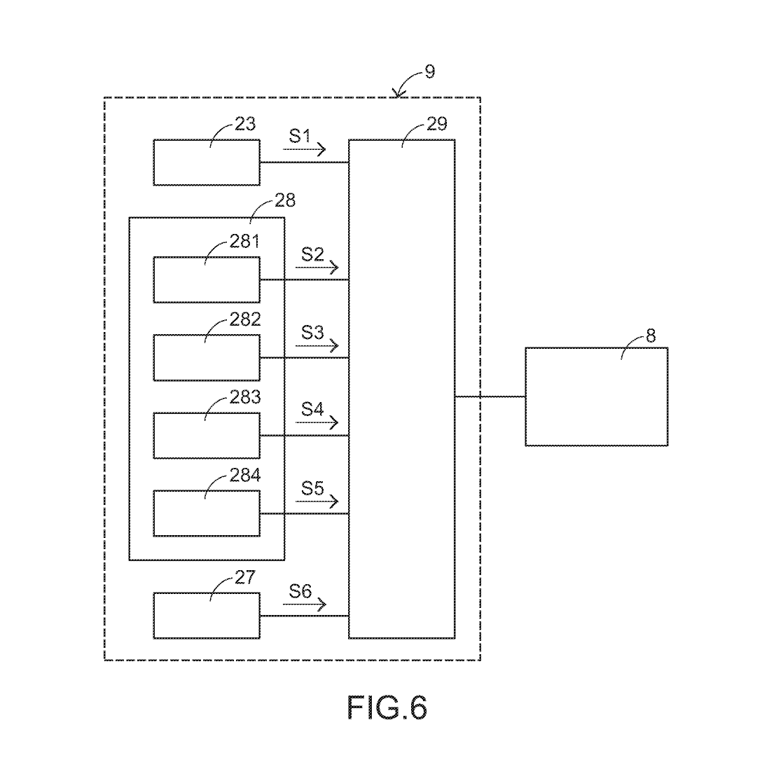

FIG. 2 illustrates a structural schematic view of a roller module for an input device according to a first preferred embodiment of the present invention, FIG. 3 illustrates a structural schematic view from another angle of the roller module as shown in FIG. 2, FIG. 4 illustrates a perspective explosion view the roller module as shown in FIG. 2, FIG. 5 illustrates a perspective explosion view from another angle of the roller module as shown in FIG. 2, and FIG. 6 illustrates a schematic block diagram of electrical connection relationships among each of the elements of the roller module as shown in FIG. 2. Referring to FIG. 2 to FIG. 6, the roller module 2 comprises a circuit board 21, a wheel swinging element 22 arranged above the circuit board 21, a wheel 23 arranged on the wheel swinging element 22 and having an operation surface 231, a first elastomer 24, a second elastomer 25, a wheel sensing element 26, a mode switching element 27, a trigger sensing element set 28 and a micro control unit 29. Herein, the mode switching element 27, the trigger sensing element set 28 and the micro control unit 29 are all arranged on the circuit board 21, and the micro control unit 29 is electrically connected with the mode switching element 27, the trigger sensing element set 28 and the wheel sensing element 26.

In addition, the mode switching element 27 and the trigger sensing element set 28 are located between the circuit board 21 and the wheel swinging element 22, and the wheel 23 is capable of being rotated or upwardly and downwardly moved relative to the wheel swinging element 22. Moreover, the wheel sensing element 26 connects with the wheel 23, so as to be upwardly and downwardly moved along with the wheel 23 and generate a wheel signal Si to the micro control unit 29 in response to a rotation distance or a rotation speed of the wheel 23. In a preferred embodiment, the wheel sensing element 26 can be an encoder.

Furthermore, the wheel 23 synchronously brings the wheel swinging element 22 to swing or to move relative to the circuit board 21 when the wheel 23 is poked and thus tilted toward a direction by a user with a finger or pressed by a user with a finger. As a result, at least a switch in the trigger sensing element set 28 or the mode switching element 27 is capable of being triggered, so as to generate corresponding control signals S2 to S5 or a mode switching signal S6 to the micro control unit 29. In contrast, when the finger of the user stops poking the wheel 23, the wheel swinging element 22 returns to an initial position in response to a second elastic force provided by the second elastomer 25.

It should be noted that the roller module 2 is switched from a first working mode to a second working mode or switched from a second working mode to a first working mode when the micro control unit 29 receives the mode switching signal S6. In addition, the micro control unit 29 generates and thus outputs a corresponding function command to an electronic equipment 8, which is in communication with an input device 9, in response to the working mode thereof and the wheel signal S1 or the control signals S2 to S5, so as to achieve a result of controlling the electronic equipment 8, which is further exemplarily illustrated as below.

In the first preferred embodiment, the trigger sensing element set 28 comprises a first switch 281, a second switch 282, a third switch 283 and a fourth switch 284 arranged at a front side, a rear side, a left side and a right side of the circuit board 21 respectively, and a bottom surface 229 of the wheel swinging element 22 has a first trigger portion 221, a second trigger portion 222, a third trigger portion 223 and a fourth trigger portion 224 respectively correspond to the first switch 281, the second switch 282, the third switch 283 and the fourth switch 284.

Herein, the wheel 23 synchronously brings the wheel swinging element 22 to swing toward a direction D5 when the wheel 23 tilts toward the direction D5 in response to the poke provided by the user, and thus the first trigger portion 221 triggers the first switch 281, so as to generate and thus output the first control signal S2 to the micro control unit 29. In contrast, the wheel 23 synchronously brings the wheel swinging element 22 to swing toward a direction D6 when the wheel 23 tilts toward the direction D6 in response to the poke provided by the user, and thus the second trigger portion 222 triggers the second switch 282, so as to generate and thus output the second control signal S3 to the micro control unit 29. In addition, the wheel 23 synchronously brings the wheel swinging element 22 to swing toward a direction D7 when the wheel 23 tilts toward the direction D7 in response to the poke provided by the user, and thus the third trigger portion 223 triggers the third switch 283, so as to generate and thus output the third control signal S4 to the micro control unit 29. In contrast, the wheel 23 synchronously brings the wheel swinging element 22 to swing toward a direction D8 when the wheel 23 tilts toward the direction D8 in response to the poke provided by the user, and thus the fourth trigger portion 224 triggers the fourth switch 284, so as to generate and thus output the fourth control signal S5 to the micro control unit 29.

Moreover, in the first preferred embodiment, the mode switching element 27 is located at a center among the first switch 281, the second switch 282, the third switch 283 and the fourth switch 284, and a height of the mode switching element 27 is higher than a height of each one of the first switch 281, the second switch 282, the third switch 283 and the fourth switch 284. In addition, a bottom surface 229 of the wheel swinging element 22 has a press trigger portion 225 corresponding to the mode switching element 27, and the second elastomer 25 is made of rubber material and formed around the mode switching element 27.

Furthermore, the wheel 23 synchronously brings the wheel swinging element 22 to move downward when the wheel 23 moves downward in response to the press provided by the user, and thus the press trigger portion 225 triggers the mode switching element 27, so as to generate and thus output the mode switching signal S6 to the micro control unit 29. It should be noted that the second elastomer 25 made of rubber material is formed around the mode switching element 27. As a result, no matter which direction mentioned above the wheel 23 tilts or moves toward, the second elastomer 25 provides the second elastic force to the wheel swinging element 22 for returning the wheel swinging element 22 to the status before being swung or being moved when the user stops swinging or pressing the wheel 23.

Moreover, in the first preferred embodiment, an upper surface 228 of the wheel swinging element 22 has a first supporting piece 226, a second supporting piece 227 and a friction piece 220 located under the wheel 23 and having a high friction coefficient. In addition, there is a first position limiting hole 2261 formed on the first supporting piece 226 and there is a second position limiting hole 2271 formed on the second supporting piece 227. Furthermore, the wheel 23 has a wheel shaft 232 passing through the wheel sending element 26, and two ends of the wheel shaft 232 respectively pass through the first position limiting hole 2261 and the second position limiting hole 2271. Herein, the first position limiting hole 2261 and the second position limiting hole 2271 are respectively used for limiting the two ends of the wheel shaft 232 to be merely moved within the first position limiting hole 2261 and the second position limiting hole 2271.

Besides, the first elastomer 24 is formed as a bar, surrounds and is fixed on the first supporting piece 226 and the second supporting piece 227, and is capable of supporting the two ends of the wheel shaft 232, such that the two ends of the wheel shaft 232 are located at first positions P1 of the first position limiting hole 2261 and the second position limiting hole 2271 respectively.

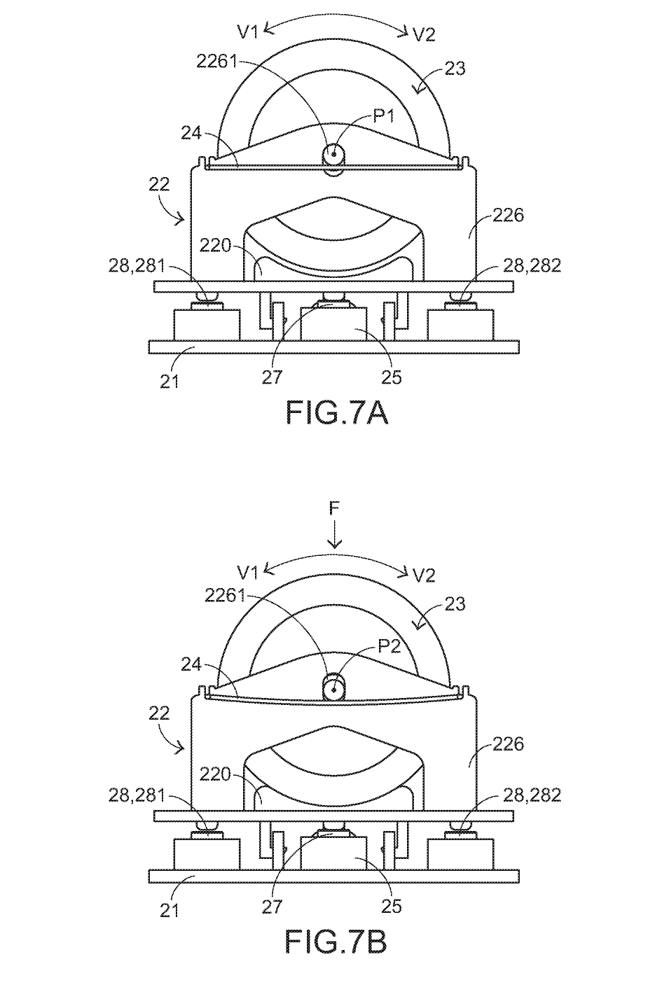

Referring to FIG. 7A and FIG. 7B, wherein FIG. 7A illustrates a schematic state view of the roller module as shown in FIG. 2 in an initial state, and FIG. 7B illustrates a schematic state view of the roller module as shown in FIG. 2 in a wheel locked state. FIG. 7A illustrates the user can easily rotate the wheel 23 toward a direction V1 or a direction V2 when the operation surface 231 of the wheel 23 does not contact with the friction piece 220. In contrast, FIG. 7B illustrates the operation surface 231 of the wheel 23 contacts with the friction piece 220 when an external force F is provided to the wheel 23 and thus the wheel 23 is moved downward for a length L relative to the wheel swinging element 22, i.e. the two ends of the wheel shaft 232 are respectively moved from the first positions P1 of the first position limiting hole 2261 and the second position limiting hole 2271 to second positions P2 of the first position limiting hole 2261 and the second position limiting hole 2271. Because the friction piece 220 has the high friction coefficient, it is not likely to rotate the wheel 23 toward the direction V1 or the direction V2 relative to the wheel swinging element 22. In such an instance, the user can further pokes and thus tilts the wheel 23 toward any one of the direction D5, the direction D6, the direction D7 and the direction D8, so as to swing the wheel swinging element 22 to trigger the corresponding one of the switches 281 to 284.

It should be noted that the wheel 23 can be moved downward relative to the wheel swinging element 22 only if the external force F is larger than the first elastic force of the first elastomer 24, and if the elastic modulus of the second elastomer 25 larger than the elastic modulus of the first elastomer 24 is even better. As a result, when the external force F is provided to the wheel 23, the wheel swinging element 22 is not swung or moved relative to the circuit board 21, but the wheel 23 is moved relative to the wheel swinging element 22 only. For this reason, it is unable to accidentally trigger any one of the first switch 281, the second switch 282, the third switch 283, the fourth switch 284 and the mode switching element 27. Certainly, it is necessary to provide an another external force larger than the second elastic force of the second elastomer 25 to the wheel 23 if the user desires to bring the wheel swinging element 22 to swing or to move relative to the circuit board 21 by poking the wheel 23.

Besides, the two ends of the wheel shaft 232 are respectively moved upward to the first positions P1 of the first position limiting hole 2261 and the second position limiting hole 2271 in response to the first elastic force provided by the first elastomer 24 when the external force F is stopped being provided to the wheel 23. Hence, the operation surface 231 of the wheel 23 is separated from the friction piece 220, and thus the wheel 23 can be rotated toward the direction V1 or the direction V2 relative to the wheel swinging element 22 again, i.e. the roller module 2 is returned to the status as illustrated in FIG. 7A.

According to the above mentioned descriptions, it can be understood that the user can press down the wheel 23 by providing the external force F first for limiting the rotation of the wheel 23 due to contacting with the friction piece 220 when the user desires to trigger the first switch 281, the second switch 282, the third switch 283, the fourth switch 284 or the mode switching element 27. After that, the user can tilt the wheel 23 toward the corresponding direction or move the wheel 23 downward by further providing the another external force to the wheel 23, and thus the wheel 23 is unable to be synchronously rotated due to the user improperly provides the external force. In another word, it is unable to synchronously achieve the rotation of the wheel 23 and the swing or the downward movement of the wheel swinging element 22, so that the micro control unit 29 can clearly determine which one of the functions mentioned above should be processed due to the wheel signal S1 and any one of the control signals S2 to S5 will not be received at the same time. As a result, it is able to avoid the incorrect operation.

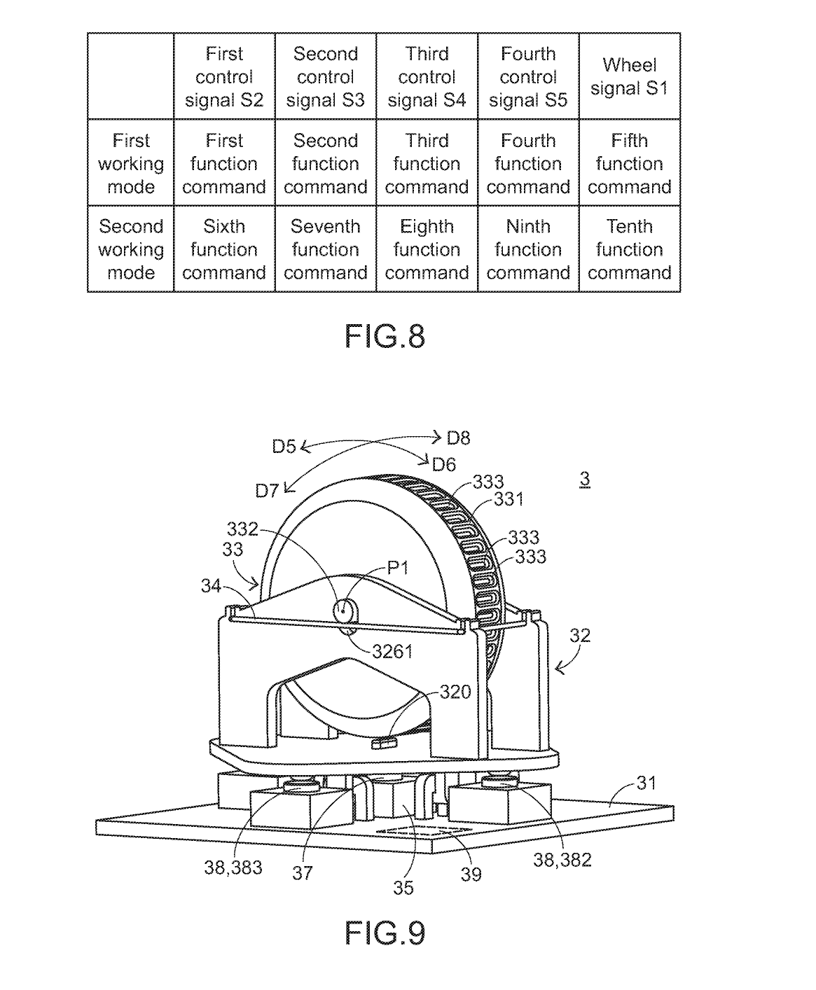

Referring to FIG. 8, which illustrates a schematic operation function table of the roller module as shown in FIG. 2 in different working modes. The electronic equipment 8 mentioned herein is a computer system equipped with an operating system (OS) and a plurality of application programs.

First, the operation functions that the roller module 2 can provide in a first working mode are described here. If the first control signal S2 is received, the micro control unit 29 generates and thus outputs a first function command to the computer system. If the second control signal S3 is received, the micro control unit 29 generates and thus outputs a second function command to the computer system. If the third control signal S4 is received, the micro control unit 29 generates and thus outputs a third function command to the computer system. If the fourth control signal S5 is received, the micro control unit 29 generates and thus outputs a fourth function command to the computer system. Besides, if the wheel signal Si is received, the micro control unit 29 generates and thus outputs a fifth function command to the computer system.

In a preferred embodiment, the first function command and the second function command can shift the image of the window on the computer screen to a previous one page and a next one page respectively, the third function command and the fourth function command can scroll the image of the window on the computer screen in the horizontal directions, and the fifth function command can scroll the image of the window on the computer screen in a vertical direction. However, the above mentioned descriptions are only a practice aspect and thus should not be considered as a limitation. In another word, person having ordinary skill in the art can practice the present feature with any equivalent variation or modification design according to his actual application requirements.

Next, the operation functions that the roller module 2 can provide due to the mode switching element 27 is triggered and thus switching the roller module 2 from the first working mode to the second working mode are described here. In the second working mode, if the first control signal S2 is received, the micro control unit 29 generates and thus outputs a sixth function command to the computer system. If the second control signal S3 is received, the micro control unit 29 generates and thus outputs a seventh function command to the computer system. If the third control signal S4 is received, the micro control unit 29 generates and thus outputs an eighth function command to the computer system. If the fourth control signal S5 is received, the micro control unit 29 generates and thus outputs a ninth function command to the computer system. Besides, if the wheel signal Si is received, the micro control unit 29 generates and thus outputs a tenth function command to the computer system.

In a preferred embodiment, the sixth function command, the seventh function command, the eighth function command and the ninth function command can be respectively set for providing a forward pointing function, a rearward pointing function, a leftward pointing function and a rightward pointing function to the computer system. For example, the user can make a selection from a menu of the image of the window on the computer screen by the above mentioned pointing functions. However, the above mentioned descriptions are only a practice aspect and thus should not be considered as a limitation. In another word, person having ordinary skill in the art can practice the present feature with any equivalent variation or modification design according to his actual application requirements.

In another preferred embodiment, the sixth function command, the seventh function command, the eighth function command and the ninth function command can further be set for switching among the application programs in the computer system. For example, a present application program can be switched to a Word application program by the sixth function command, the present application program can be switched to an Excel application program by the seventh function command, the present application program can be switched to a Powerpoint application program by the eighth function command and the present application program can be switched to a multimedia player program by the ninth function command. However, the above mentioned descriptions are only a practice aspect and thus should not be considered as a limitation. In another word, person having ordinary skill in the art can practice the present feature with any equivalent variation or modification design according to his actual application requirements.

Certainly, if the mode switching element 27 is triggered again, the roller module 2 can be switched from the second working mode to the first working mode, or be switched from the second working mode to a third working mode (not shown in FIG. 8). Similarly, person having ordinary skill in the art can practice the present feature with any equivalent variation or modification design according to his actual application requirements.

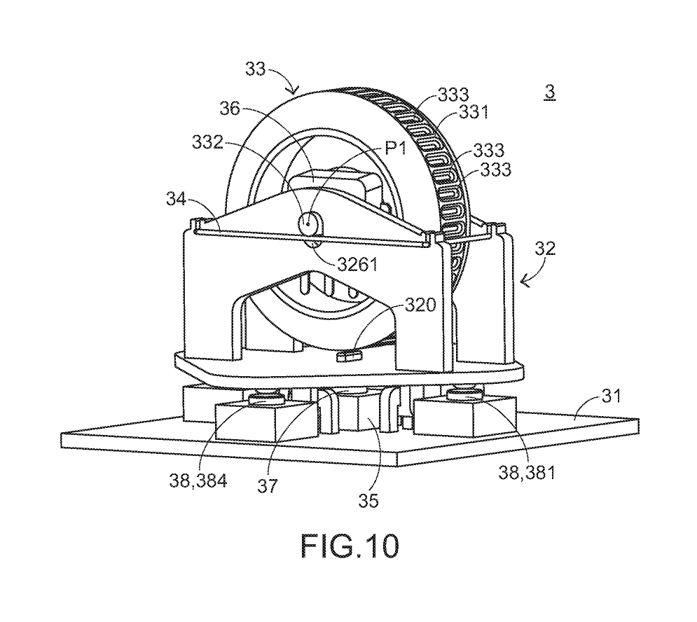

Referring to FIG. 9 and FIG. 10, wherein FIG. 9 illustrates a structural schematic view of a roller module for an input device according to a second preferred embodiment of the present invention, and FIG. 10 illustrates a structural schematic view from another angle of the roller module as shown in FIG. 9. Herein, the roller module 3 of the present embodiment is substantially similar to that illustrated in the first preferred embodiment of the present invention. For example, the roller module 3 comprises a circuit board 31, a wheel swinging element 32 arranged above the circuit board 31, a wheel 33 arranged on the wheel swinging element 32 and having an operation surface 331, a first elastomer 34, a second elastomer 35, a wheel sensing element (not shown), a mode switching element 37, a trigger sensing element set 38 and a micro control unit 39 as well. Besides, the trigger sensing element set 38 comprises a first switch 381, a second switch 382, a third switch 383 and a fourth switch 384 respectively arranged at a front side, a rear side, a left side and a right side of the circuit board 31 as well.

The differences between the present preferred embodiment and the foregoing first preferred embodiment are the operation surface 331 of the wheel 33 of the roller module 3 having a plurality of recessions 333 thereon and the wheel swinging element 32 having a protrusion 320 thereon and located under the wheel 33.

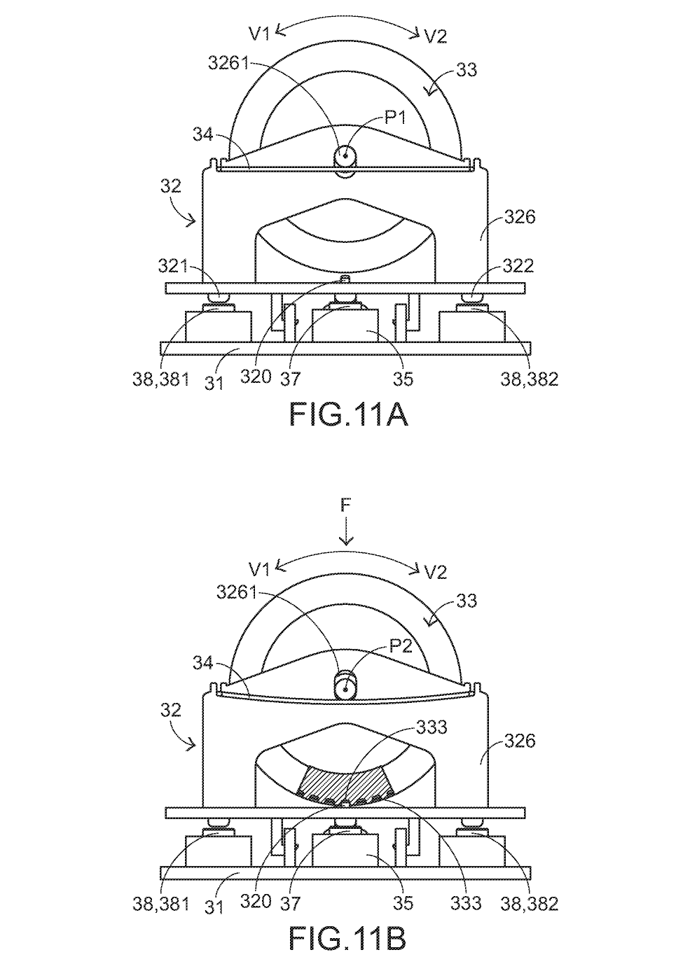

FIG. 11A illustrates a schematic state view of the roller module as shown in FIG. 9 in an initial state, and FIG. 11B illustrates a schematic state view of the roller module as shown in FIG. 9 when the wheel is in a locked state. Referring to FIG. 11A and FIG. 11B, the portion filled with a hatch pattern in FIG. 11B herein illustrates a cross-sectional aspect of a portion of the wheel 33 in order to facilitate the understanding of the following descriptions.

FIG. 11A illustrates that the user can rotate the wheel 33 toward the direction V1 or the direction V2 relative to the wheel swinging element 32 when the protrusion 320 of the wheel swinging element 32 is separated from the recessions 333 of the operation surface 331 of the wheel 33. In contrast, FIG. 11B illustrates the protrusion 320 on the wheel swinging element 32 is contained within a recession 333 of the plurality of recessions 333 for limiting the rotation of the wheel 33 when an external force F is provided to the wheel 33 and thus the wheel 33 is moved downward for a length L relative to the wheel swinging element 32, i.e. two ends of the wheel shaft 332 are moved from first positions P1 of a first position limiting hole 3261 and a second position limiting hole 3271 to second positions P2 of the first position limiting hole 3261 and the second position limiting hole 3271 respectively. In such an instance, the user can further pokes and thus tilts the wheel 33 toward any one of the direction D5, the direction D6, the direction D7 and the direction D8 as illustrated in FIG. 9, so as to swing the wheel swinging element 32 to trigger the corresponding one of the switches 381 to 384 as illustrated in FIG. 9 and FIG. 10.

Similarly, the wheel 33 can be moved downward relative to the wheel swinging element 32 only if the external force F is larger than a first elastic force of the first elastomer 34, and if an elastic modulus of the second elastomer 35 larger than an elastic modulus of the first elastomer 34 is even better. As a result, when the external force F is provided to the wheel 33, the wheel swinging element 32 is not swung or moved relative to the circuit board 31, but the wheel 33 is moved relative to the wheel swinging element 32 only. For this reason, it is unable to accidentally trigger any one of the first switch 381, the second switch 382, the third switch 383, the fourth switch 384 and the mode switching element 37. Certainly, it is necessary to provide an another external force larger than the second elastic force of the second elastomer 35 to the wheel 33 if the user desires to bring the wheel swinging element 32 to swing or to move relative to the circuit board 31 by poking the wheel 33.

Besides, the two ends of the wheel shaft 332 are respectively moved upward to the first positions P1 of the first position limiting hole 3261 and the second position limiting hole 3271 in response to the first elastic force provided by the first elastomer 34 when the external force F is stopped being provided to the wheel 33. Therefore, the protrusion 320 on the wheel swinging element 32 is separated from the recessions 333 of the operation surface 331 of the wheel 33 the friction piece 220, and thus the wheel 33 can be rotated toward the direction V1 or the direction V2 relative to the wheel swinging element 32 again, i.e. the roller module 3 is returned to the status as illustrated in FIG. 10A.

According to the above mentioned descriptions, it can be understood that the user can press down the wheel 33 by providing the external force F first for limiting the rotation of the wheel 33 when the user desires to trigger the first switch 381, the second switch 382, the third switch 383, the fourth switch 384 or the mode switching element 37. After that, the user can tilt the wheel 33 toward the corresponding direction or move the wheel 33 downward by further providing the another external force to the wheel 33, and thus the wheel 33 is unable to be synchronously rotated due to the user improperly provides the external force. In another word, it is unable to synchronously achieve the rotation of the wheel 33 and the swing or the downward movement of the wheel swinging element 32, so that the micro control unit 39 can clearly determine which one of the functions mentioned above should be processed due to the wheel signal and any one of the control signals will not be received at the same time. As a result, it is able to avoid the incorrect operation.

It should be noted that, as those illustrated in the first preferred embodiment, the roller module 3 can be switched from a first working mode to a second working mode or switched from a second working mode to a first working mode when the micro control unit 39 receives the mode switching signal S6. Besides, the micro control unit 39 generates and thus outputs a corresponding function command to an electronic equipment 8, which is in communication with an input device 9, in response to the working mode thereof and the wheel signal S1 or the control signals S2 to S5, so as to achieve a result of controlling the electronic equipment 8, and the result is substantially similar to those illustrated in FIG. 8 and is omitted herein.

In addition, the above mentioned structures of the roller modules are illustrated as two kinds of preferred embodiment only. In another word, those preferred embodiments mentioned above are not intent to limit the number of the switches of the trigger sensing element set and the arranged positions thereof, the arranged position of the mode switching element, the number of the trigger portions of the wheel swinging element and the arranged positions thereof, and the material, the number and the arranged position of the elastomer. Hence, person having ordinary skill in the art can practice the present feature with any equivalent variation or modification design according to his actual application requirements.

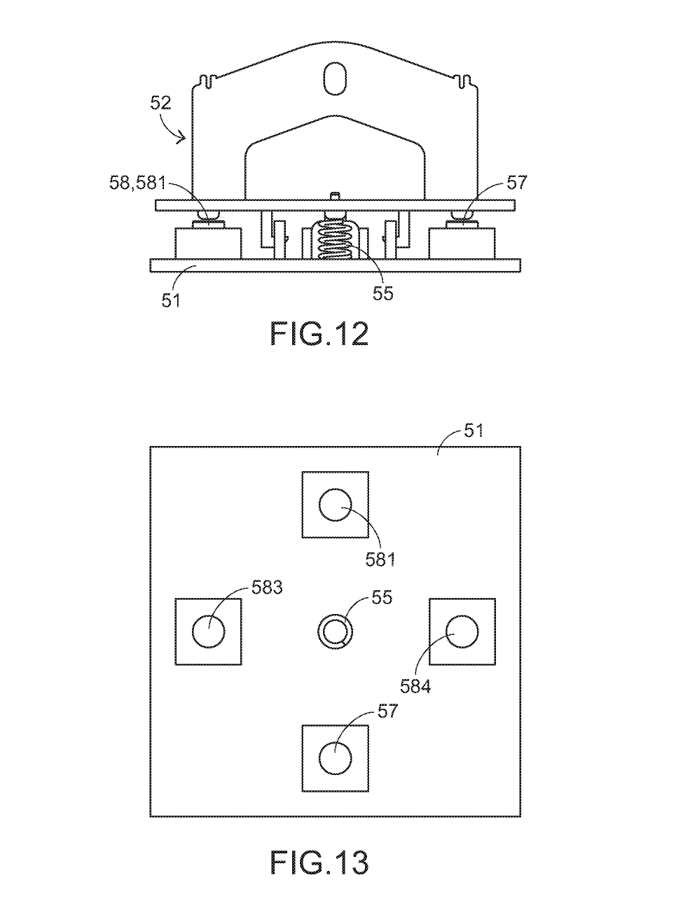

FIG. 12 and FIG. 13 illustrate an additional example of the present invention, wherein FIG. 12 illustrates a structural schematic view of a circuit board, a second elastomer and a wheel swinging element of a roller module according to an embodied aspect of the present invention, and FIG. 13 illustrates a top view of the circuit board, the second elastomer and the wheel swinging element as shown in FIG. 12. Herein, referring to FIG. 12 and FIG. 13, the trigger sensing element set 58 comprises a first switch 581, a third switch 583, a fourth switch 384 and a mode switching element 57 as well, and the second elastomer 55 is a spring and arranged between the circuit board 51 and the wheel switching element 52. In another word, FIG. 12 particularly illustrates that either the second elastomer 24 in the first preferred embodiment or the second elastomer 35 in the second preferred embodiment can further be replaced by a spring.

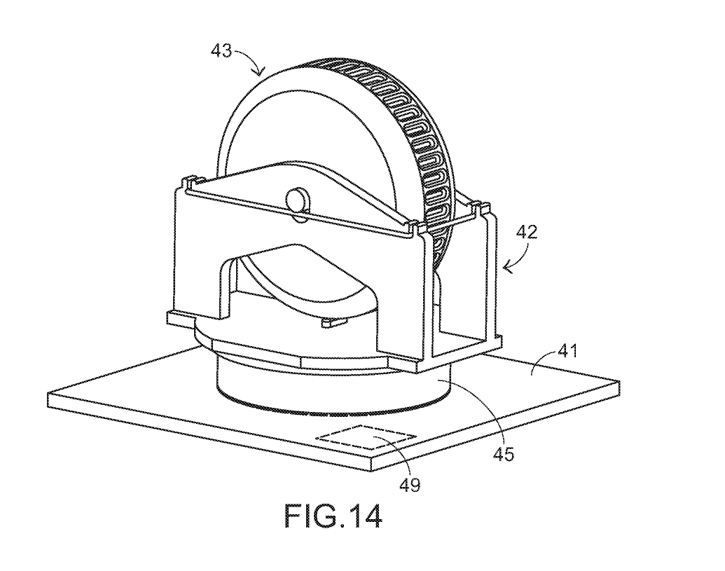

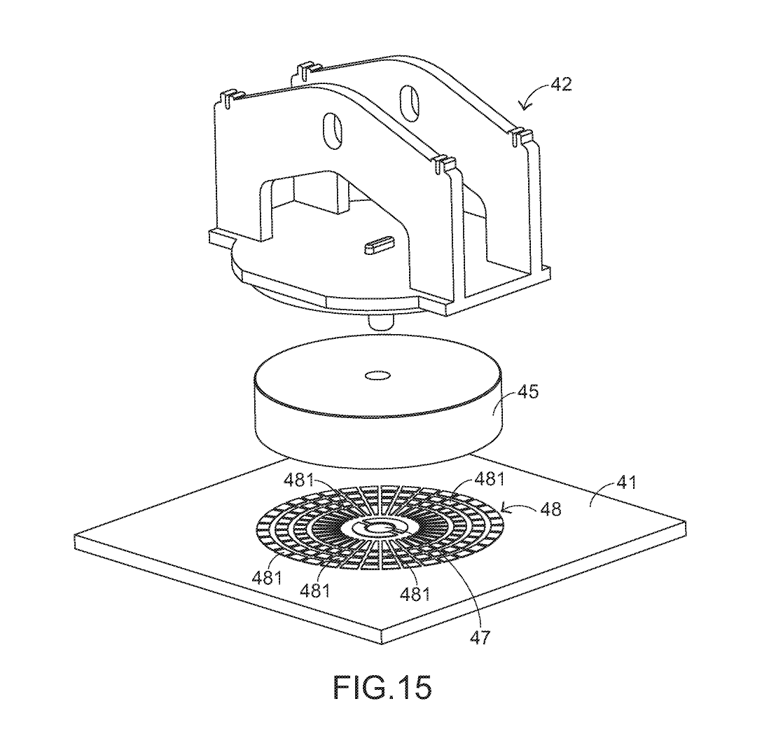

FIG. 14 and FIG. 15 illustrate another additional example of the present invention, wherein FIG. 14 illustrates a structural schematic view of a circuit board, a second elastomer and a wheel swinging element of a roller module according to another embodied aspect of the present invention, and FIG. 15 illustrates a perspective explosion view of the circuit board, the second elastomer and the wheel swinging element as shown in FIG. 14. Referring to FIG. 14 and FIG. 15, the trigger sensing element set 48 comprises a plurality of switches 481 formed on the circuit board 41, the plurality of switches 481 are arranged to form a 360 degrees arrangement, and the mode switching element 47 is arranged at a center among the plurality of switches 481. The second elastomer 45 is arranged between the circuit board 41 and the wheel swinging element 42. In a preferred embodiment, the trigger sensing element set 48 is a resistance type pressure sensor or a capacitance type pressure sensor, and the second elastomer 45 is an electro-conductive rubber.

Herein, when the wheel swinging element 42 is swung toward any one direction or moved downward due to the wheel 43 on the wheel swinging element 42 is operated by the user, the second elastomer 45 is compressed and thus contact with a corresponding one of the switches 481 or the mode switching element 47, so as to trigger the corresponding one of the switches 481 or the mode switching element 47. In contrast, when the wheel 43 on the wheel swinging element 42 is not poked by the user, the wheel swinging element 42 is returned to an initial position due to a second elastic force generated by compressing the second elastomer 45. It should be noted that since the plurality of switches 481 are arranged to form a 360 degrees arrangement, the input device of the present invention can be designed to generate and thus output a corresponding one of control signals to the micro control unit 49 when any one of the switches 481 is triggered. As a result, the micro control unit 49 can generate and thus output a function command with an orientation to the electronic equipment 8 as shown in FIG. 6, i.e. the roller module of the present invention can be used as a joystick.

Certainly, as those illustrated in the first preferred embodiment and the second preferred embodiment, the roller module can be switched from a first working mode to a second working mode or switched from a second working mode to a first working mode when the micro control unit 49 receives the mode switching signal. In addition, the micro control unit 49 generates and thus outputs a corresponding one of the above mentioned function commands to the electronic equipment 8, which is in communication with the input device 9, in response to the working mode thereof and the wheel signal or the control signals, so as to achieve a result of controlling the electronic equipment 8, and the result is substantially similar to those illustrated in FIG. 8 and is omitted herein.

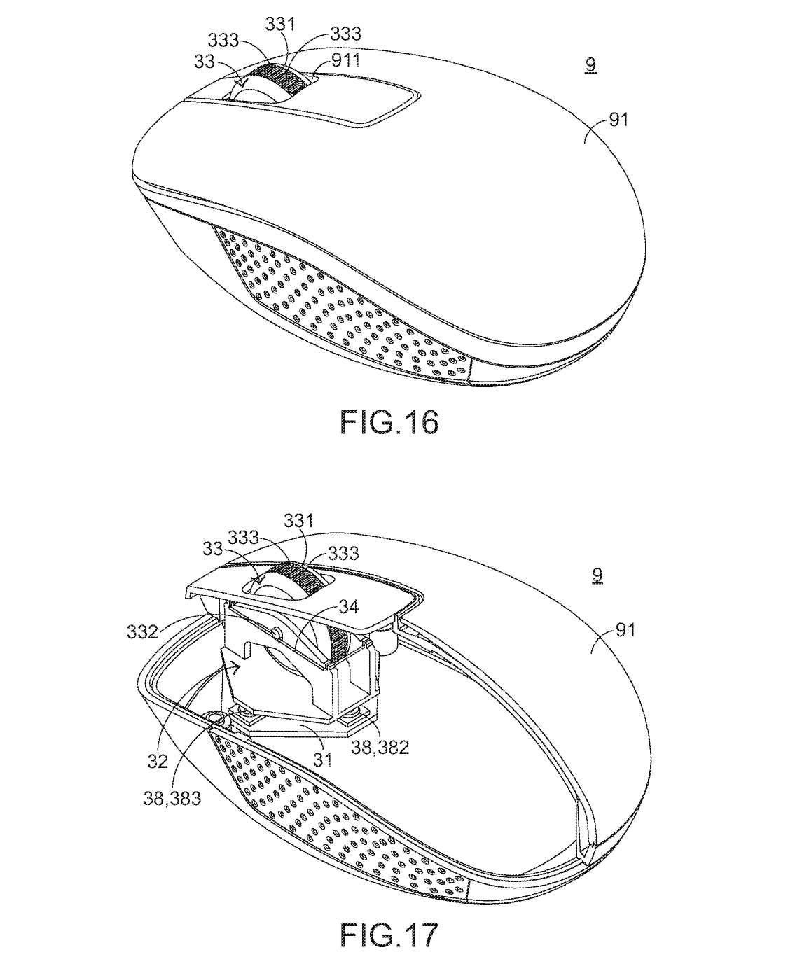

FIG. 16 and FIG. 17 illustrate a further additional example of the present invention, wherein FIG. 16 illustrates a structural schematic view of a roller module for an input device according to a preferred embodied aspect of a second preferred embodiment of the present invention, and FIG. 17 illustrates a partial internal structural schematic view of the input device as shown in FIG. 16. Herein, referring to FIG. 16 and FIG. 17, the input device 9 is a mouse device. The input device 9 has a case 91 capable of being held by the user for moving the input device 9. In addition, there is an opening 911 formed on an upper surface of the case 91 and capable of exposing a portion of the wheel 33 of the roller module 3 outside the case 91, such that the user can poke or press the wheel 33 exposed outside the case 91 with his finger. Similarly, the roller module 2 as illustrated in the first preferred embodiment can be applied to a mouse device with the same arrangement as well and thus omitted herein.

Certainly, the application of the roller module is merely illustrated as a preferred embodiment, and person having ordinary skill in the art can further practice the application with any equivalent variation or modification design according to his actual application requirements. In another word, person having ordinary skill in the art can assemble the roller module of the present invention on other input devices, such as a keyboard device, a personal digital assistant (PDA) and so on, with the same arrangement according to the revelation obtained from the above mentioned preferred embodiments.

According to the above mentioned preferred embodiments, it is understood that the roller module for an input device has at least one of the advantages: (1) the wheel of the roller module can be locked, and thus the wheel is unable to be rotated even if the user use the mouse device as a joystick in an improper way; (2) the roller module has a sufficient number of the switches, so as to provide much more variations of the operation functions to the user; and (3) the user can switch the working modes of the roller module and process all of the functions by operating the roller module with only one finger.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A roller module for an input device, comprising:
a mode switching element, capable of being triggered to generate a mode switching signal;
a trigger sensing element set, capable of being triggered to correspondingly generate and thus output at least one control signal;
a circuit board, wherein the mode switching element and the trigger sensing element set are capable of being arranged on the circuit board;
a wheel swinging element, arranged above the circuit board, such that the mode switching element and the trigger sensing element set are located between the circuit board and the wheel swinging element;
a wheel, arranged on the wheel swinging element and capable of being rotated relative to the wheel swinging element, wherein the wheel is unable to be rotated when the wheel is provided with an external force and moved downward a distance relative to the wheel swinging element, and the mode switching element or the trigger sensing element set is triggered when the wheel is unable to be rotated and the wheel is provided with another external force for swinging or moving the wheel swinging element relative to the circuit board;
a first elastomer, capable of providing a first elastic force to the wheel, such that the wheel is moved upward relative to the wheel swinging element when the wheel is stopped to be provided with the external force;
a wheel sensing element, arranged adjacent to the wheel and capable of generating and thus outputting a wheel signal when the wheel rotates; and
a micro control unit, electrically connected with the mode switching element, the trigger sensing element set and the wheel sensing element, wherein the roller module is switched from a first working mode to a second working mode when the micro control unit receives the mode switching signal.

2. The roller module for an input device as claimed in claim 1, wherein the micro control unit generates and thus outputs a first function command when the roller module is in the first working mode and the micro control unit receives the at least one control signal, while the micro control unit generates and thus outputs a second function command when the roller module is in the second working mode and the micro control unit receives the at least one control signal.

3. The roller module for an input device as claimed in claim 1, wherein the micro control unit generates and thus outputs a first function command when the roller module is in the first working mode and the micro control unit receives the wheel signal, while the micro control unit generates and thus outputs a second function command when the roller module is in the second working mode and the micro control unit receives the wheel signal.

4. The roller module for an input device as claimed in claim 1, wherein the wheel has an operation surface for an user operating thereon, the operation surface has a plurality of recessions thereon, the wheel swinging element has a protrusion located under the wheel, and the protrusion is contained within a recession of the plurality of recessions when the roller module is in a swinging mode.

5. The roller module for an input device as claimed in claim 1, wherein the wheel has an operation surface for an user operating thereon, an upper surface of the wheel swinging element has a friction piece, and the wheel contacts the friction piece when the roller module is in a swinging mode.

6. The roller module for an input device as claimed in claim 1, wherein the wheel swinging element has a first supporting piece and a second supporting piece, the wheel has a wheel shaft, and two ends of the wheel shaft are respectively arranged on the first supporting piece and the second supporting piece.

7. The roller module for an input device as claimed in claim 6, wherein the first supporting piece has a first position limiting hole thereon, the second supporting piece has a second position limiting hole thereon, the two ends of the wheel shaft respectively pass through the first position limiting hole and the second position limiting hole, the first position limiting hole is capable of limiting one of the two ends of the wheel shaft to be merely moved in the first position limiting hole, and the second position limiting hole is capable of limiting the other one of the two ends of the wheel shaft to be merely moved in the second position limiting hole.

8. The roller module for an input device as claimed in claim 7, wherein the first elastomer is formed as a bar, which encircles and is fixed on the first supporting piece and the second supporting piece, and is capable of supporting the two ends of the wheel shaft.

9. The roller module for an input device as claimed in claim 1, wherein the trigger sensing element set comprises a first switch, a second switch, a third switch and a fourth switch, a bottom surface of the wheel swinging element has a first trigger portion, a second trigger portion, a third trigger portion and a fourth trigger portion respectively corresponding to the first switch, the second switch, the third switch and the fourth switch, and the first switch, the second switch, the third switch and the fourth switch are respectively arranged at a front side, a rear side, a left side and a right side on the circuit board.

10. The roller module for an input device as claimed in claim 9, wherein the mode switching element is arranged among the first switch, the second switch, the third switch and the fourth switch, and the bottom surface of the wheel swinging element has a press trigger portion corresponding to the mode switching element.

11. The roller module for an input device as claimed in claim 10, wherein the mode switching element is an elastomer with an elastic modulus larger than an elastic modulus of the first elastomer.

12. The roller module for an input device as claimed in claim 10, wherein the first switch and the second switch are respectively capable of controlling an image of a window on a computer screen to shift to a previous one page and a next one page when the roller module is in the first working mode.

13. The roller module for an input device as claimed in claim 10, wherein the third switch and the fourth switch are respectively capable of horizontally scrolling an image of a window on a computer screen when the roller module is in the first working mode.

14. The roller module for an input device as claimed in claim 10, wherein the first switch, the second switch, the third switch and the fourth switch are respectively capable of providing a forward pointing function, a rearward pointing function, a leftward pointing function and a rightward pointing function when the roller module is in the second working mode.

15. The roller module for an input device as claimed in claim 10, wherein at least one of the first switch, the second switch, the third switch and the fourth switch is capable of switching among application programs in a computer system when the roller module is in the second working mode.

16. The roller module for an input device as claimed in claim 1, further comprising at least one second elastomer arranged between the wheel swinging element and the circuit board and capable of providing a second elastic force for the wheel swinging element.

17. The roller module for an input device as claimed in claim 16, wherein an elastic modulus of the second elastomer is larger than an elastic modulus of the first elastomer.

18. The roller module for an input device as claimed in claim 16, wherein the second elastomer is made of rubber material.

19. The roller module for an input device as claimed in claim 1, wherein the trigger sensing element set is a resistance type pressure sensor or a capacitance type pressure sensor.

20. The roller module for an input device as claimed in claim 1, wherein the wheel sensing element is an encoder.

21. The roller module for an input device as claimed in claim 1, wherein the input device comprises a case, and an upper surface of the case has an opening capable of exposing a part of the wheel outside the case.

22. The roller module for an input device as claimed in claim 1, wherein the input device is applied to a mouse device, a keyboard device or a mobile device.
